(19) United States
(12) Patent Application Publication
(10) Pub. No.: US 2020/0390231 A1
(43) Pub. Date: Dec. 17, 2020

(54) CLEANER

(71) Applicant: Patrick Jeremy Rice, New South Wales (AU)

(72) Inventor: Patrick Jeremy Rice, New South Wales (AU)

(21) Appl. No.: 16/915,570

(22) Filed: Jun. 29, 2020

Related U.S. Application Data
(63) Continuation of application No. 15/711,912, filed on Sep. 21, 2017, now abandoned.
Application No. 15/711,912 is a continuation of application No. 14/813,050, filed on Jul. 29, 2015, now abandoned.
Application No. 14/813,050 is a continuation of application No. 14/498,947, filed on Sep. 26, 2014, now abandoned.
Application No. 14/498,947 is a continuation of application No. 13/138,172, filed on Jul. 15, 2011, now abandoned.

(30) Foreign Application Priority Data
Jan. 16, 2009 (AU) 2009900182

(51) Int. Cl. A46B 17/06; A46B 11/06; B44D 3/00

(52) U.S. Cl. CPC A46B 17/06; A46B 2200/202; B44D 3/006; A46B 11/063

(57) ABSTRACT

A cleaning apparatus; said apparatus combining mechanical combing action and liquid flow to remove detritus from frond-like structures.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### SUMMARY OF THE INVENTION

The present invention relates to the cleaning of items by controlled application of a stream of fluid and, more particularly, but not exclusively to the cleaning of paintbrushes and like items which have a strand-like structure.

### BACKGROUND OF THE INVENTION

### Field of the Invention

The cleaning of items or structures made from strands or fronds can be difficult.

For example the cleaning of paintbrushes after use is both a time consuming and inefficient process. Although various liquid and mechanical cleaning systems have been devised, in the case of the latter these may be complicated, relatively expensive, themselves difficult to clean and generally unsatisfactory.

It is an object of the present invention to address or at least ameliorate some of the above disadvantages or at least provide a useful alternative.

### Definitions

In this specification the term “frond like structure” is to be taken to refer to a structure which incorporates strands or filaments usually in a substantially parallel alignment. Specific but not limiting examples of such structures include the bristles in a paintbrush or the aligned hair in a horse's tail.

Accordingly, in one broad form of the invention there is provided cleaning apparatus; said apparatus combining mechanical combing action and liquid flow to substantially remove detritus from structures incorporating frond-like structures.

Preferably said frond like structures comprise the bristles of a paintbrush.

Preferably said mechanical combing action is provided by a multi-tyned comb structure; tynes of said multi-tyned comb structure adapted for intrusion into, and longitudinal movement through or between bundles of said frond like structures.

Preferably said liquid flow issues from at least one liquid flow orifice adjacent an outer end of each tyne of said multi-tyned comb structure.

Preferably said at least one orifice is arranged so as to direct said liquid flow substantially parallel to each tyne of said multi-tyned comb structure.

Preferably said liquid flow is arranged in a fine, narrow fan-shaped jet issuing from said orifice.

Preferably said liquid is water.

Preferably said tynes of said multi-tyned comb structure extend from a manifold body portion of said apparatus.

Preferably said manifold body portion extends from a handle portion shaped for grasping by the hand of a user.

Preferably each of said tynes of said multi-tyned structure is formed with hard edges so as to act as scrapers as said tyne moves between bristles of a said paintbrush.

Preferably said manifold portion of said structure is formed with hard edges which act as scrapers as said tynes move through said frond like structure.

Preferably said handle portion is provided with a connector spigot at one end of said handle portion; said connector spigot adapted for connection to socket outlet fitting of a water supply hose.

Preferably said handle portion, said manifold body portion, said tynes of said multi-tyneed structure and said connector spigot, form an integral unitary structure.

Preferably said integral unitary structure is formed by a blow moulding process.

In a further broad form of the invention there is provided a method of substantially removing residual paint from the bristles of a paintbrush; said method including the steps of;

connecting a paintbrush cleaning apparatus to a water supply hose,

pushing tynes of a multi-tyneed structure of said paintbrush cleaning apparatus between bristle bundles of said paintbrush,

repeatedly moving said tynes from an initial location adjacent the head of said paintbrush to the end of said bristle bundles, and

wherein fan-shaped jets of water issuing from an orifice located between said tynes act to dislodge said residual paint from said bristles.

Preferably steps (a) to (c) are repeated for each side of said paintbrush.

Preferably said fan-shaped jets of water issue from one side of each of said tynes; said jets issuing substantially normal to said multi-tyneed structure.

Preferably said apparatus is moved along a side of said paintbrush in such a manner that said fan-shaped jets of water urge said residual paint towards the ends of said bristles.

Thus in yet a further broad form of the invention there is provided a method of substantially removing residue from a frond like structure; said method including the steps of;

A) connecting a cleaning apparatus to a water supply,

B) pushing tynes of a multi-tyned structure of said cleaning apparatus between or through the fronds of said frond like structure

wherein fan-shaped jets of water issuing from an orifice located between said tynes act to dislodge said residue.

### BRIEF DESCRIPTION OF THE DRAWINGS

Embodiments of the present invention will now be described with reference to the accompanying drawings wherein:

FIG. 1 is a perspective view of a cleaning apparatus according to a preferred embodiment of the invention,

FIG. 2 is a further perspective view of the apparatus of FIG. 1 showing a preferred spray pattern,

FIG. 3 is a perspective view of the apparatus of FIGS. 1 and 2 when applied to a paintbrush in use

FIG. 4 is a perspective view of a cleaner according to a second preferred embodiment and

FIG. 5 is a side view of the cleaner of FIG. 4.

### DETAILED DESCRIPTION OF THE PREFERRED EMBODIMENT

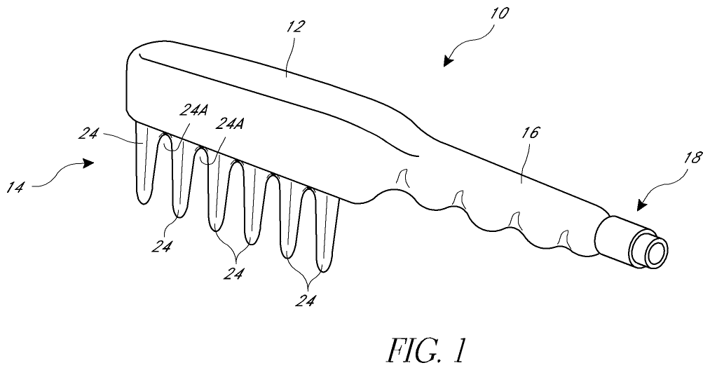

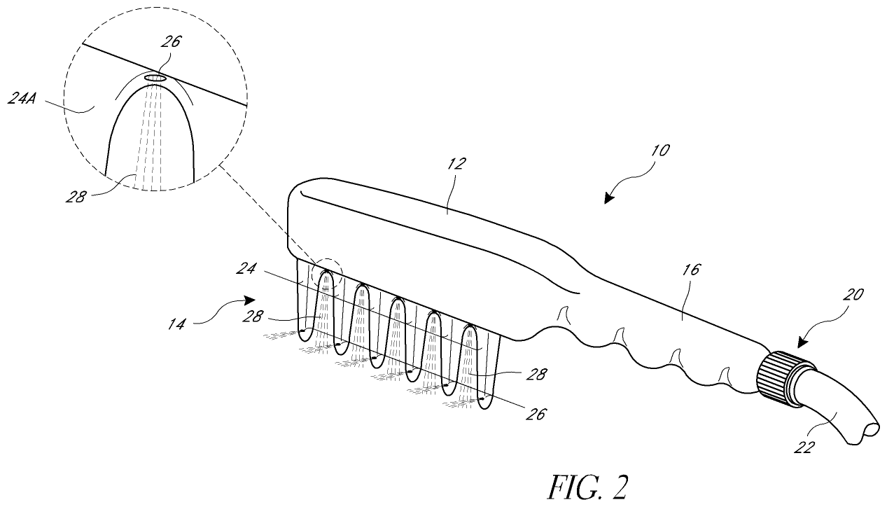

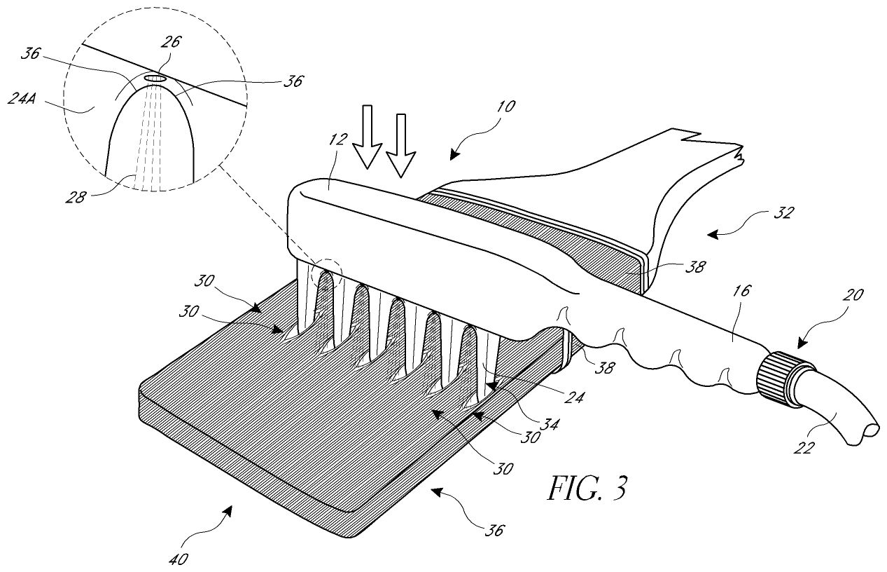

With reference to FIGS. 1 to 3, in a first preferred embodiment of the invention, a cleaning apparatus 10 includes a manifold body portion 12 from which extends a multi-tyne comb structure 14. Apparatus 10 further includes a handle portion 16 extending from manifold body portion 12, and a spigot 18 to which may be connected a connection socket 20 of a water supply hose 22, as can be seen in FIGS. 2 and 3.

Preferably, manifold body portion 12, the comb structure 14, handle portion 16 and spigot 18 form a unitary integral whole, and are hollow. Thus the inside of each tyne 24 is in fluid communication with manifold body portion 12 which in turn is in fluid communication with the handle portion 14 and spigot 18. Preferably, the apparatus 10 is blow moulded from a suitable polymer.

In a preferred form the tynes 24 are arranged so as to be substantially parallel to each other and spaced apart from each other as illustrated with arcuate grooves 24A defined therebetween.

Each arcuate groove 24A is provided with an orifice 26 as shown in the inset of FIG. 2. Preferably, each orifice 26 is so formed as to create a fan-shaped jet 28 of water when water is caused to enter the apparatus 10 under pressure. Preferably, the jet 28 issues between the tynes 24 and substantially parallel to the comb structure 14.

Each tyne 24 of comb structure 14, is adapted for intrusion into the fronds of a frond like structure such as bundles of bristles 30 of a paintbrush 32 as can be seen in FIG. 3. The leading edges 34 of the tynes may be hard or sharp edges, so formed to act as scrapers against the bristles 36 of the paintbrush 32 during longitudinal movement of the apparatus relative to the bristles of the paintbrush.

### In Use

As soon as practicable after use of a paintbrush 32, the apparatus 10 of a preferred embodiment of the invention is connected to a water supply hose 22 and, while holding the paintbrush 32 over a suitable waste water receptacle (not shown), the tynes 24 of the apparatus and the water jets 28 issuing from between the tynes, are insinuated between the bristles 36 from a first side of the paintbrush. In a preferred form insertion can be as close as possible to the head, or ferule 38 of the paintbrush with the water jets 28 directed towards the outer ends 40 of the bristles 36. The apparatus 10 is then moved towards the ends 40 of the bristles, dragging the tynes 24 of the comb structure 14 through the bristles. The water jets 28 then urge paint residue dislodged by the force of the jets 28 and the scraping action of the edges 34 of the tynes 24, towards and off the ends of the bristles.

As can be seen in the inset of FIG. 3 the bristles 36 become compacted against the arcuate structure 24A in the region where the water jet first emerges from orifice 26 from where the water then flows along the path of least resistance between the tynes and away from body portion 12.

This action may be repeated a number of times before applying the same procedure to the other side of the paintbrush. The whole process of application to one side and then the other of the paintbrush, may be repeated a number of times until the residual paint is substantially removed from the bristles.

### Second Embodiment

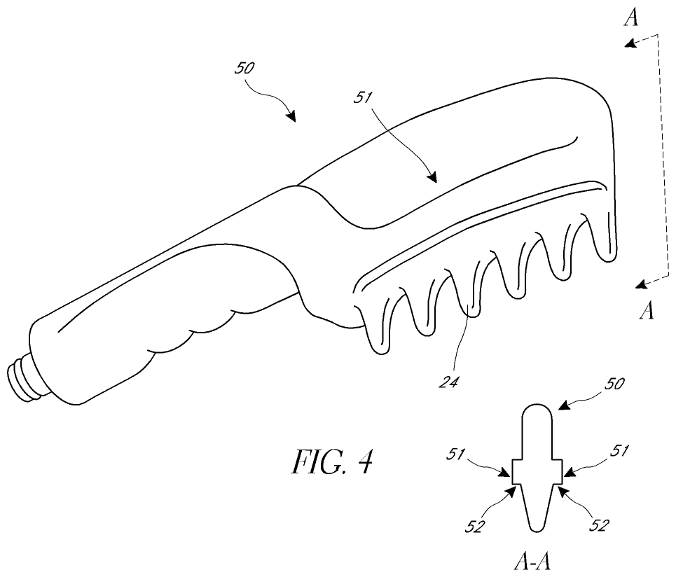

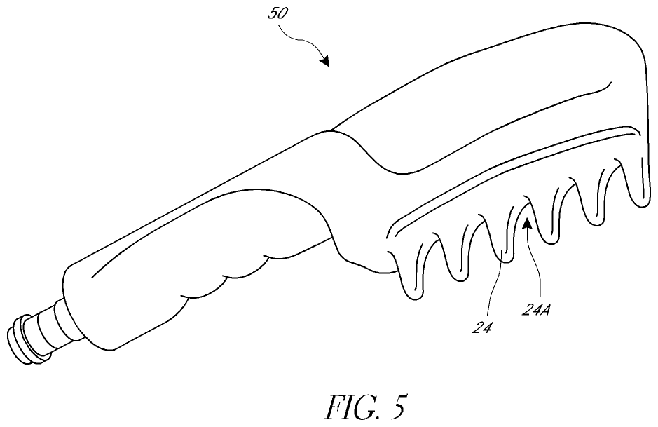

With reference to FIGS. 4 and 5 there is illustrated a cleaner 50 in accordance with a second preferred embodiment of the present invention. The structure is substantially the same as that for the first embodiment and like components are numbered accordingly. As can be seen in front view inset AA of FIG. 4 a ridge structure 51 is defined on each side of the line of tynes. This ridge structure 51 includes a hard edge 52 which acts to scrape against the bristles of the paintbrush so as to remove hardened paint or like detritus.

The above describes only some embodiments of the present invention and modifications, obvious to those skilled in the art, can be made thereto without departing from the scope of the present invention. Thus, for example, although the above description has focused on the use of water, it will be understood that with a suitable pressurised source, other liquids such as detergents, thinners and other cleaning agents may be passed through the apparatus and otherwise in accordance with the method of the invention.

Also, the handle portion 16 may receive alternative connections to it so as to allow, for example, connection to different kinds of hoses or connection to other accessories such as a soap dispenser.

What is claimed is:

1. A cleaning apparatus; said apparatus combining mechanical combing action and liquid flow to substantially remove detritus from structures incorporating frond-like structures.

2. The cleaning apparatus of claim 1 wherein said frond like structures comprise the bristles of a paintbrush.

3. The apparatus of claim 1 wherein said mechanical combing action is provided by a multi-tyned comb structure; tynes of said multi-tyned comb structure adapted for intrusion into, and longitudinal movement through or between bundles of said frond like structures.

4. The apparatus of claim 3 wherein said liquid flow issues from at least one liquid flow orifice adjacent an outer end of each tyne of said multi-tyned comb structure.

5. The apparatus of claim 4 wherein said at least one orifice is arranged so as to direct said liquid flow substantially parallel to each tyne of said multi-tyned comb structure.

6. The apparatus of claim 4 wherein said liquid flow is arranged in a fine, narrow fan-shaped jet issuing from said orifice.

7. The apparatus of claim 1 wherein said liquid is water.

8. The apparatus of claim 3 wherein said tynes of said multi-tyned comb structure extend from a manifold body portion of said apparatus.

9. The apparatus of claim 8 wherein said manifold body portion extends from a handle portion shaped for grasping by the hand of a user.

10. The apparatus of claim 3 wherein each of said tynes of said multi-tyned structure is formed with hard edges so as to act as scrapers as said tyne moves between bristles of a said paintbrush.

11. The apparatus of claim 1 wherein said manifold portion of said structure is formed with hard edges which act as scrapers as said tynes move through said frond like structure.

12. The apparatus of claim 9 wherein said handle portion is provided with a connector spigot at one end of said handle portion; said connector spigot adapted for connection to socket outlet fitting of a water supply hose.

13. The apparatus of claim 12 wherein said handle portion, said manifold body portion, said tynes of said multi-tyneed structure and said connector spigot, form an integral unitary structure.

14. The apparatus of claim 13 wherein said integral unitary structure is formed by a blow moulding process.

15. A method of substantially removing residual paint from the bristles of a paintbrush; said method including the steps of;
A) connecting a paintbrush cleaning apparatus to a water supply hose,
B) pushing tynes of a multi-tyneed structure of said paintbrush cleaning apparatus between bristle bundles of said paintbrush,
C) repeatedly moving said tynes from an initial location adjacent the head of said paintbrush to the end of said bristle bundles, and
wherein fan-shaped jets of water issuing from an orifice located between said tynes act to dislodge said residual paint from said bristles.

16. The method of claim 15 wherein steps (a) to (c) are repeated for each side of said paintbrush.

17. The method of claim 15 wherein said fan-shaped jets of water issue from one side of each of said tynes; said jets issuing substantially normal to said multi-tyneed structure.

18. The method of claim 15 wherein said apparatus is moved along a side of said paintbrush in such a manner that said fan-shaped jets of water urge said residual paint towards the ends of said bristles.

19. A method of substantially removing residue from a frond like structure; said method including the steps of;
A) connecting a cleaning apparatus to a water supply,
B) pushing tynes of a multi-tyned structure of said cleaning apparatus between or through the fronds of said frond like structure
wherein fan-shaped jets of water issuing from an orifice located between said tynes act to dislodge said residue.
